(19) United States
(12) Patent Application Publication
(10) Pub. No.: US 2006/0096637 A1
(43) Pub. Date: May 11, 2006

(54) Bistable membrane valve

(75) Inventors: Michel Maquaire, Ardon (FR); David Adrion, Roanne (FR)

Correspondence Address: OLIFF & BERRIDGE, PLC, P.O. BOX 19928, ALEXANDRIA, VA, 22320, US

(73) Assignee: Syegon, Versailles (FR)

(21) Appl. No.: 10/519,360

(22) PCT Filed: Jun. 18, 2003
(86) PCT No.: PCT/FR03/01870

§ 371 Date: Aug. 11, 2005

(30) Foreign Application Priority Data
Jun. 28, 2002 (FR) 02/08064

(51) Int. Cl. F16K 15/20

(52) U.S. Cl. 137/224

(57) ABSTRACT

A single valve that includes an openwork semi-rigid membrane having two stable positions and a seat. The single valve is actuated by a pressure differential between the inside and the outside of the semi-rigid membrane. In a first position, the single valve prevents fluid circulation and, in a second position, the single valve allows fluid circulation. The single valve is applicable to an inflating and deflating valve for pneumatics of vehicles tires.

### CROSS-REFERENCE TO RELATED APPLICATION

This application is the National Stage of International Application No. PCT/FR03/001870 filed Jun. 18, 2003. This application also claims priority from French Patent Application No. 02.08064 filed Jun. 28, 2002. The entire disclosures of the previous applications are hereby incorporated by reference to their entirety.

### BACKGROUND

The present invention relates to valves and to the use of valves in inflation and deflation valves to inflate and deflate the tire of a motor vehicle wheel.

There exists valves that allow the remote inflation and deflation of vehicle tires (U.S. Pat. No. 4,922,946 and French Patent Nos. 2,667,826 and 2,731,655). The single valves (of inflation and deflation valves) allow the passage of pressurized air to the tire when in one position, allow air contained in the tire to escape to the exterior when in a second position, and isolate the tire by closing off the air flow circuit when in a resting position.

To achieve this, a membrane is subjected to a spring and coupled with a single valve formed of a chamber and closing means. The closing means currently employed is that of a ball. This system has proved efficient in heavy vehicles.

### SUMMARY

The drawback to this system lies in the fact that the internal pressure of the tire of light vehicles is much lower and the wheel spin rate is much greater than that of heavy vehicle tires. These different factors cause the inflation and deflation valves to malfunction, essentially because of the centrifugal forces applied to the ball or to the vertical accelerations to which the vehicle's wheels may be subjected.

The present invention thus overcomes, among other things, this problem by proposing a single valve that fulfils the same role but whose production costs are reduced and whose constituents will remain unaffected by those forces likely to generate malfunctions.

The present invention thus proposes the replacement of the single valve comprising a seat, a steel ball and a barrier grid for the ball, by a single valve constituted by a seat and a membrane having two stable positions.

The invention thus relates to a single valve that closes an inflation circuit and is composed of a seat and a semi-rigid membrane with one or several openings and which is structured to successively adopt two stable positions.

### BRIEF DESCRIPTION OF THE DRAWINGS

Other characteristics, particulars and advantages of the invention will become more apparent from the description given hereafter by way of illustration and in reference to the drawings, in which:

FIG. 1a shows a top view of the bistable membrane,

FIG. 1b shows a section of the bistable membrane in a first stable condition,

FIG. 1c shows a section of the bistable membrane in a second condition,

FIG. 1d shows a section of a bistable membrane incorporating a core grid,

FIG. 2a shows a section of the bistable membrane valve in a first stable condition,

FIG. 2b shows a section of the bistable membrane valve in a second stable condition, and

FIGS. 3a to 3c are sections, at a different scale, of an inflation and deflation valve.

### DETAILED DESCRIPTION OF EMBODIMENTS

The single valve proposed by the invention is composed of a seat and an openwork bistable membrane (a bistable membrane with one or several openings). This single valve is intended to be inserted into an inflation and deflation valve such as is described in French Patent No. 2,731,655.

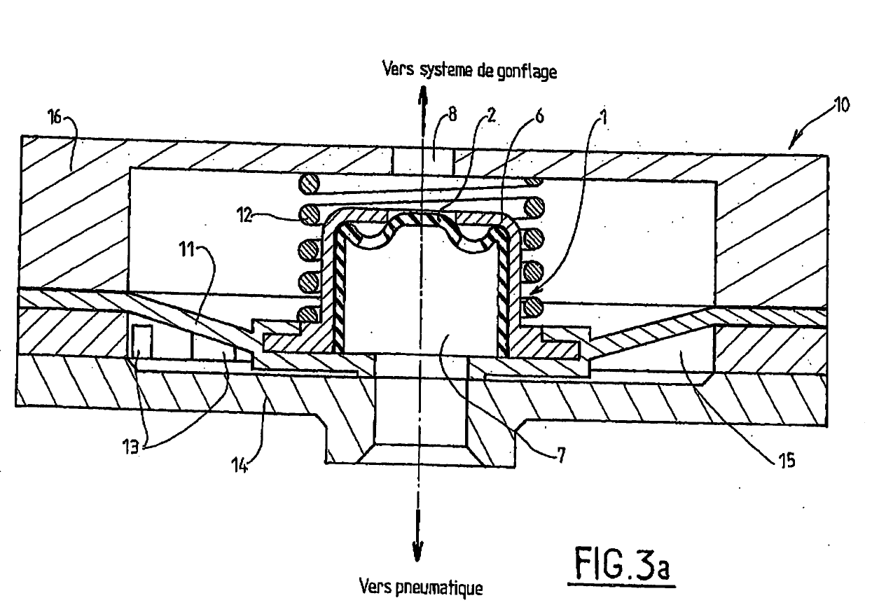

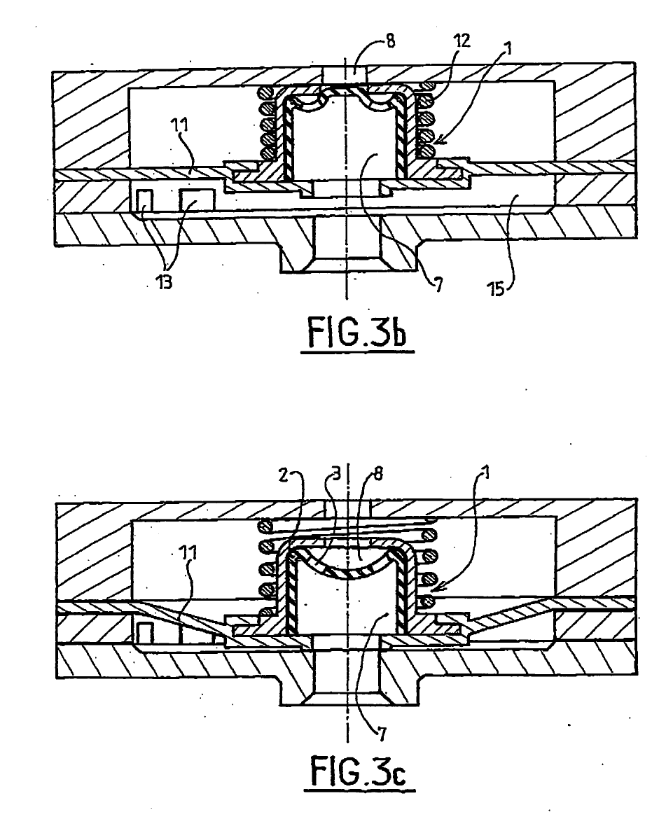

FIG. 3a shows an inflation and deflation valve 10 formed of a single valve 1, a spring 12, a valve membrane 11, a base 14 and a cap 16. The valve 10 is connected to a tire (not shown) via a bore in the base 14. Via a bore made in the cap 16, a chamber 8 of the valve 10 is connected to a pressurising/depressurising system (not shown). The chamber 15, delimited by the valve membrane 11 and the base 14, communicates with the exterior via slots 13. The single valve 1 used, according to the invention, includes a seat 6 and a bistable membrane 2.

Since the operation of the inflation and deflation valve and the pressurizing system are already described in the aforementioned patent (French Patent No. 2,731,655), reference may easily be made to this document for a more detailed explanation.

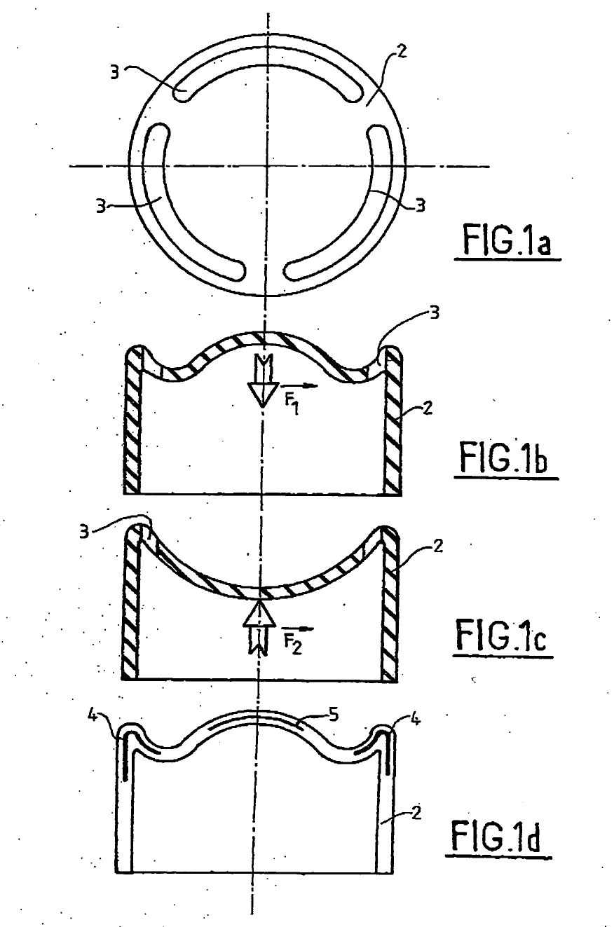

FIGS. 1a to 1d show a top view of a bistable membrane 2, and a section view of the bistable membrane 2 in both stable positions. The bistable membrane 2 is a body of revolution (i.e., cylindrical body) with a cylindrical wall and a bottom with openings 3. The body may be made of a semi-rigid material, for example a polymer (rubber, latex, etc.), a stamped metal sheet, or else a polymer molded over core grids 4 and 5 (by duplicate molding an elastomer onto a metallic core grid). Another embodiment of the membrane may be envisaged if the embodiment enables the membrane 2 to have two stable positions. FIGS. 1a to 1c show a semi-rigid polymer membrane and FIG. 1d shows a membrane with core grids 4 and 5. The core grids 4 and 5 may, for example, be made of metal or plastic. To make the membrane 2 move from the first stable condition (FIG. 1b) to the second stable condition (FIG. 1c), a force F must be applied inwards and at a magnitude greater than or equal to the minimal transition force F₁. The force F₁ depends on the constitutive material or materials, the shape of the membrane 2 and the temperature. Under the effect of this force F, the central part of the membrane 2 is displaced towards the inside of the membrane, thus moving from a high position to a low position. Conversely, to move the membrane 2 from the second stable condition into the first stable condition, a force F′, oriented outwards and greater than or equal to the minimal transition force F₂ must be applied.

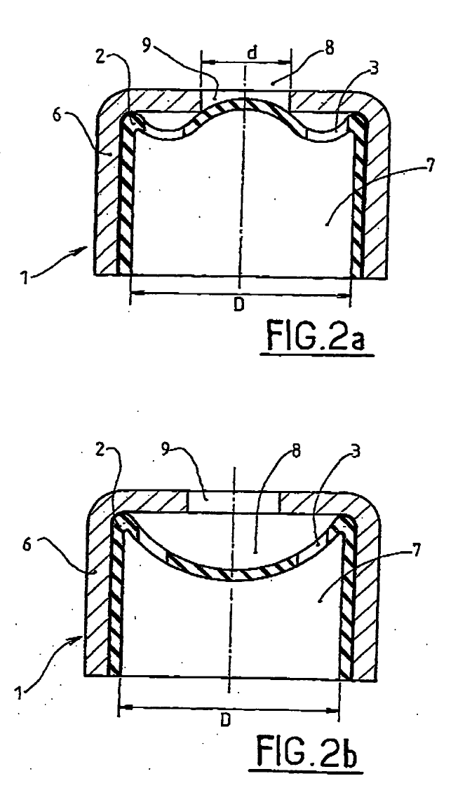

FIGS. 2a and 2b show the single valve 1, composed of the bistable membrane 2 and the seat 6. The seat 6 is of a revolution (i.e., cylindrical body) and incorporates at a center an opening 9 of a diameter d. When the membrane 2 is in a first stable condition shown in FIG. 2a, the central part of the membrane presses on the periphery of the opening 9 thereby ensuring the total isolation of a chamber 7 inside the single valve 1 and an enclosed space 8 located above the single valve 1. Openings 3 are positioned such that, in the first stable condition of the membrane 2, fluid does not circulate between the chamber 7 and enclosed space 8. To move from the first stable condition into the second stable condition, a force F greater than F₁ must be applied to the upper part of the membrane 2. The force F₁ is made here by the difference in pressure between the chamber 7 and the enclosed space 8. The minimal pressure enabling a change in condition is:
P₈≧P₇+4*F₁/Πd²
Where P₇ is the pressure in the chamber 7 and P₈ the pressure in the enclosed space 8.

Conversely, the passage of the membrane 2 from the second stable condition into the first stable condition is made by the flow of a fluid through the openings 3, which creates a difference in pressure between the chamber 7 and the enclosed space 8. The maximum condition transition pressure is thus:
P₈≦P₇−F₂/S
where S is the contact surface of the upper part of the membrane 2, subjected to the difference in pressure between the chamber 7 and the enclosed space 8.

If we consider that the openings 3 have a total area s, and that the membrane 2 has an inner diameter D, the value of S may easily be calculated:
S=ΠD²/4−s

The openings 3 will thus be dimensioned according to the technical characteristics of the membrane 2 and the difference in pressure required to be obtained during the flow of fluid.

FIGS. 3a to 3c show the integration of the single valve 1 according to the invention into an inflation and deflation valve 10. FIG. 3a shows the inflation and deflation valve 10 in its resting position, with the pressure in chamber 7 being identical to the tire pressure and the pressure in the enclosed space 8 substantially equal to the atmospheric pressure. A spring 12 holds the valve membrane 11 against the base 14 and the bistable membrane 2 is in a stable position blocking the single valve 1. The inflation and deflation valve 10 is thus fully sealed. The inflation and deflation valve 10 fitted with the single valve 1 according to the invention has a very simple technical structure where the single valve 1 has just two elements to ensure the opening and closing of the inflation and deflation valve 10. Such a single valve 1 namely improves the reliability and stability of the inflation and deflation valve 10.

FIG. 3b shows the deflation of the tire where, as described in French Patent No. 2,731,655, the enclosed space 8 is depressurized so that the pressures in chambers 7 and 15 are sufficiently greater than that in the enclosed space 8 for the spring 12 to be compressed. The valve membrane 11 moves away from the base 14 and the air contained in the tire is able to escape via openings 13. The difference in pressure of chambers 7 and 15 with respect to enclosed space 8 keeps the bistable membrane 2 in the position in which it blocks the single valve 1.

FIG. 3c shows the single valve 1 in is second stable position described above. This position enables two different operations to be performed. When the tire is being inflated, enough pressure (P₈≧P₇+4*F₁/Πd²) is applied in the enclosed space 8 to trigger the change of position in the single valve 1. The fluid is thus able to flow through openings 3, the pressure in the enclosed space 8 being greater than that in the chamber 7 and the fluid flows from the enclosed space 8 to the tire.

When the single valve 1 is in this second position, slow deflation may be performed. By progressively reducing the pressure in the enclosed space 8 so as to constantly keep it slightly under that of the chamber 7, the difference in pressure is not enough for the membrane 2 to change its position and the fluid contained in the tire escapes into the pressurization/depressurization system. In this configuration, the fluid moves from the chamber 7 to the enclosed space 8 and thus performs the slow deflation of the tire. To carry out this slow deflation, the pressure P₈ of the enclosed space 8, must be adjusted to as to obtain:
P₇≧P₈≧P₇−F₂/S
where P₇ is the pressure in the tire and thus in the chamber 7.

It is also possible for the pressure in the tire to be measured when the single valve 1 is in the second stable position. By stabilizing P₈ such that the flow of fluid through the single valve 1 is nil, P₈ and P₇ are identical, the single valve 1 remains open and the pressure in the tire may be measured using a pressure sensor in the pressure regulation system.

To return to the first stable position of the single valve 1, the pressure merely has to drop (for example by opening the supply circuit to the enclosed space 8 towards the exterior) so as to obtain the following relation:
P₈<P₇−F₂/S

The single valve 1 closes and is sealed once again.

According to an exemplary aspect of the invention, this single valve is insensitive to the centrifugal forces resulting from the high spin rate of the wheel.

According to an exemplary aspect of the invention, the use of the single valve allows the number of elements in the inflation and deflation valve to be reduced, thereby reducing production costs and simplifying manufacture.

According to an exemplary aspect of the invention, the single valve, in addition to the initial functions of the inflation and deflation valve, enables the gradual deflation of the tire.

1. A single valve, comprising:
a seat; and
a semi-rigid membrane with one or several openings and which is structured to successively adopt two stable positions.

2. The single valve according to claim 1, wherein the seat and the membrane are assembled such that the membrane in a first stable position prevents a circulation of fluid and in a second stable position allows the circulation of fluid.

3. The single valve according to claim 2, wherein the membrane is open so as to create a difference in pressure on either side of the single valve during the circulation of fluid.

4. The single valve according to claim 3, wherein the single valve is activated by the difference in pressure upstream and downstream of the single valve.

5. The single valve according to claim 4, wherein the membrane is made of a polymer.

6. The single valve according to claim 4, wherein the membrane is made by stamping a metal sheet.

7. The single valve according to claim 4, wherein the membrane is made by duplicate molding an elastomer onto a metallic core grid.

8. An inflation and deflation valve comprising the single valve according to claim 1.
